(19) United States
(12) Patent Application Publication
(10) Pub. No.: US 2026/0328965 A1
(43) Pub. Date: Oct. 22, 2026

(54) HURRICANE THREAT INDEX SYSTEMS AND METHODS

(71) Applicant: DTN. LLC, Bloomington, MN (US)

(72) Inventor: SAMUEL LILLO, Boulder, CO (US)

(21) Appl. No.: 19/655,501

(22) Filed: Apr. 22, 2026

Related U.S. Application Data
(60) Provisional application No. 63/792,439, filed on Apr. 22, 2025.

(51) Int. Cl. G01W 1/10

(52) U.S. Cl. CPC G01W 1/10

(57) ABSTRACT

A system for and method of determining a Hurricane Threat Index (“HTI”) Score representing Hazard Intensity, Hazard Exposure, and Hazard Impact. The HTI Score is calculated by aggregating weighted Intensity Metrics and Exposure Factors for a plurality of Perils.

### CROSS-REFERENCE TO RELATED APPLICATIONS

This application claims priority pursuant to 35 U.S.C. 119 (e) to U.S. Provisional Patent Application Ser. No. 63/792,439, filed Apr. 22, 2025, the entire disclosure of which is incorporated herein by reference.

### FIELD OF THE INVENTION

The present invention relates generally to storm assessments. More specifically, the present invention is concerned with systems for and methods of anticipating, preparing for, assessing, and responding to storm impacts.

### BACKGROUND

Hurricanes and other large-scale events, such as tropical storms, cyclones, and the like (each a “Hurricane”) can cause significant damage and loss of life. U.S. Patent Publication No. 2025/0102703 (“Lillo 1”), the entire disclosure of which is incorporated herein by reference, teaches a superior Tropical Storm Forecasting System and Methods, some embodiments of which provide superior hazard location information and superior hazard intensity information. While presumably satisfactory for their intended purposes, the Lillo 1 systems do not provide a comprehensive metric designed for anticipating, preparing for, assessing, and responding to a selected hurricane (a “Hurricane Threat Index” or “HTI”). Accordingly, it would be beneficial to have a system for and a method of determining a Hurricane Threat Index.

Traditional hurricane scales focus solely on wind speed to determine storm intensity, but wind is just one of several potential major perils associated with a Hurricane, and wind is not always the most concerning peril. Accordingly, it would be beneficial to have a system for and a method of determining and utilizing an intensity value for each of several perils.

As populations continue to increase, especially along coastal areas, the social impact of storms continues to increase. For instance, changes in population density, especially increased density, can complicate evacuations and can overburden mitigation and/or response efforts. Accordingly, it would be beneficial to have a system for and a method of calculating a Hurricane Threat Index that accounts for population density.

Existing hurricane indices and alerting systems are limited to meteorological classification or single-hazard analysis and do not incorporate economic exposure weighting at the peril level. In other words, existing systems provide raw weather data. While raw weather data is sufficient in many situations, weighted impact information may be necessary or beneficial in other situations, such as when preparing for or responding to a Hurricane. Accordingly, it would be beneficial to have a system for and a method of utilizing raw weather data to determine weighted impact information.

It is well known that traditional risk assessment systems and methods fail to provide sufficient information for a complete hurricane threat assessment. (See Eberenz, S., et al. (2020). Asset exposure data for global physical risk assessment. Copernicus Publications, https://doi.org/10.5194/essd-12-817-2020. (“Eberenz”), the entire disclosure of which is incorporated herein by reference). Referring to FIG. 1, Eberenz teaches a method of combining gridded nightlights information and gridded population data to compute a digital number (“Lit^{m}Popⁿ” or “LitPop”) for each grid cell. The gridded LitPop information is then used to disaggregate asset values and GDP values to obtain gridded asset exposure information and gridded GDP information, respectively. Various public resources provide economic information that was derived using the Eberenz method and/or similar methods. While presumably satisfactory for their intended purposes, the availability of such economic information is only one factor that must be considered when assessing a Hurricane, and the weight of such factors may deviate for each of several perils. Accordingly, it would be beneficial to have a system for and a method of utilizing an economic exposure factor for each of several potential perils. It would be further beneficial to have a system for and a method of enabling a wholistic approach to preparing for and responding to a Hurricane.

### SUMMARY

The present invention comprises a system for and a method of determining a Hurricane Threat Index.

Unlike conventional hurricane scales that classify storms by maximum wind speed alone, the present invention determines and utilizes an intensity value for each of several perils, such as wind, storm surge, rainfall, and tornadoes. In some such embodiments, the systems and methods of the present invention determine an intensity value for at least some of the several perils. In some embodiments, the systems and methods of the present invention determine at least one intensity value for each peril of the several perils.

In some embodiments, the Hurricane Threat Index accounts for population density.

In some embodiments, the present invention utilizes raw weather data to determine weighted impact information. In some such embodiments, the weighted impact information is provided in the form of a Hurricane Threat Index that represents peril-specific physical hazard metrics, asset-density-based exposure factors, and weighted aggregation.

In some embodiments, the present invention produces a peril-resolved, impact-weighted threat score that enables a wholistic approach to preparing for and responding to a Hurricane. In some embodiments, the present invention facilitates prioritization of asset protection and personnel safety actions based on expected operational disruption rather than categorical storm labels. In some embodiments, the present invention facilitates allocation of resources dynamically by identifying which peril type poses the dominant threat to specific assets or regions. In some embodiments, the present invention facilities optimization of timing of shutdowns, evacuations, logistics rerouting, or market hedging decisions using forward-looking threat trajectories derived from forecast model ensembles. In some embodiments, the present invention is particularly advantageous for some users, such as energy and infrastructure users, for whom certain perils, such as rainfall-driven flooding or storm surge, may present greater operational risk than other perils, such as peak winds.

In some embodiments, the present invention is natively integrated into an existing forecasting system, such as a proprietary forecasting system. In some such embodiments, such integration enables automated ingestion of deterministic and ensemble meteorological forecasts, high-resolution gridded hazard fields, and/or continuously updated asset and exposure datasets. In some embodiments, the integration facilitates calculations and recalculations in near real time as forecast guidance evolves, providing users with continuously updated threat metrics that are directly tied to a specified geographic footprint and/or the user's business exposure.

For users managing distributed asset portfolios, the present invention enables aggregation of threat assessments across multiple locations and peril types into a single comparable metric. In some embodiments, the present invention facilitates ranking facilities, regions, or supply chains by relative threat assessments, comparing storm events across seasons and geographies, and/or quantifying cumulative exposure to compound hurricane impacts. In some embodiments, the present invention provides an ability to normalize diverse hazards into a unified threat index, which is a material improvement over existing systems that require manual interpretation of disparate hazard outputs.

In some embodiments, the present invention produces a technically distinct and commercially valuable capability of providing decision-support intelligence, rather than raw weather data.

In some embodiments, the present invention facilitates translation of forecast uncertainty into measurable business risk, representing a novel and useful advancement in hurricane threat assessment systems.

The foregoing and other objects are intended to be illustrative of the invention and are not meant in a limiting sense. Many possible embodiments of the invention may be made and will be readily evident upon a study of the following specification and accompanying drawings comprising a part thereof. Various features and sub-combinations of invention may be employed without reference to other features and sub-combinations. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

Embodiments of the present invention are described in detail below with reference to the attached drawing figures, wherein:

FIG. 1, which is a reproduction of FIG. 1 from Eberenz, is a flow chart representing the LitPop downscaling discussed in Eberenz.

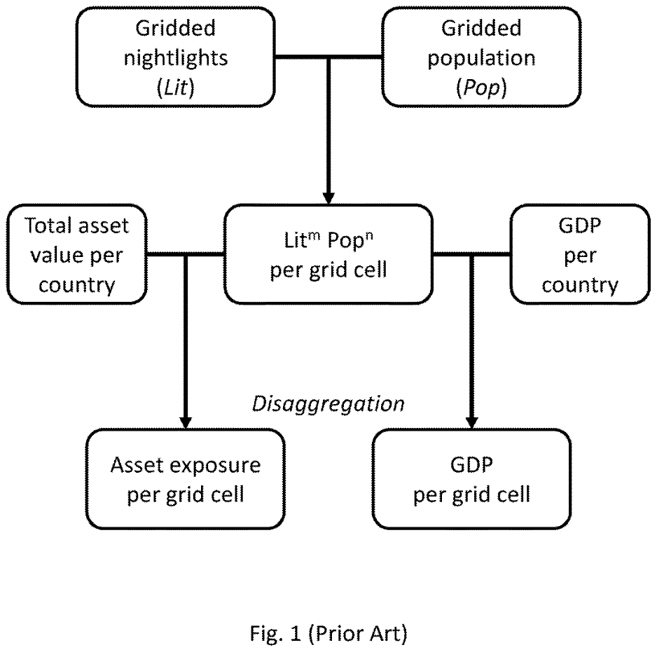

FIG. 2 is a flow chart representing an embodiment of the present invention that assesses information from four perils to determine an HTI Score for a specified HTI Location and HTI Storm.

The drawing figures do not limit the present invention to the specific embodiments disclosed and described herein. The drawings are not necessarily to scale, emphasis instead being placed upon illustrating the principles of the invention.

### DETAILED DESCRIPTION

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

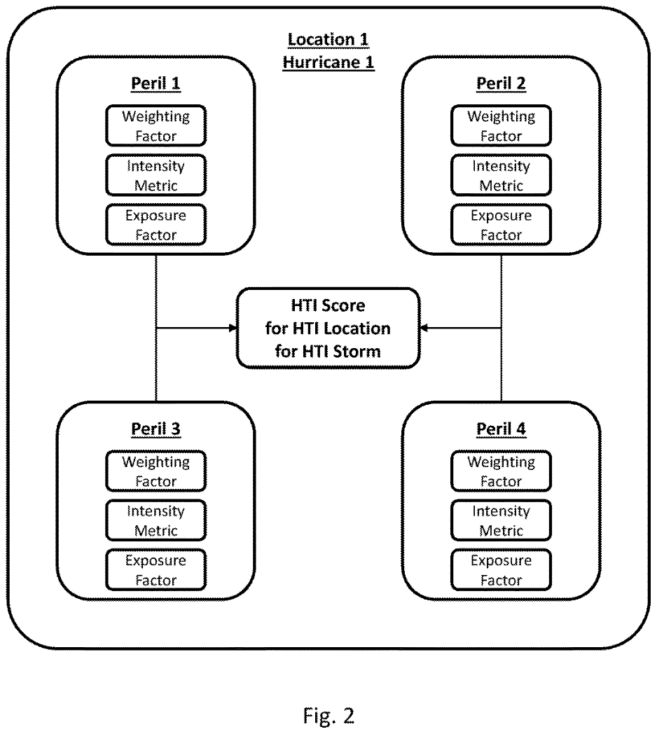

Referring to FIG. 2, the present invention comprises a system for and method of determining a Hurricane Threat Index score (the “HTI Score”) for a selected location (“HTI Location”) and a selected Hurricane (“HTI Storm”). In some embodiments, determining the HTI Score involves assessing the total destructive potential of the HTI Storm by assigning component values for each of multiple hazard types (each a “Peril”). In some embodiments, determining the HTI Score involves assessing socioeconomic exposure of the HTI Location.

The present invention evaluates a plurality of Perils. In some embodiments, the plurality of Perils includes a Wind Peril, a Storm Surge Peril, a Rainfall Peril, and a Tornado Peril. In some embodiments, Peril information includes intensity information layered with impact information. In some such embodiments, the intensity information is used to develop an intensity value (“Intensity Metric”) and the impact information is used to develop an impact value (“Exposure Factor”). In some embodiments, the impact information includes economic impact information and/or population impact information. In some embodiments, the HTI Score is an accurate and actionable threat score for a designated HTI Location and HTI Storm. In some embodiments, evaluation of the plurality of Perils includes analyzing aspects of each Peril.

In some embodiments of the present invention, determination of the Intensity Metric for the Wind Peril includes analyzing aspects of the Wind Peril. In some such embodiments, the analyzed aspects of the Wind Peril include maximum sustained wind speeds and maximum measured wind gusts measured across a storm path. In some such embodiments, measured wind values associated with multiple measuring locations are used to extrapolate Wind Peril information for the HTI location. In some embodiments, each wind value is weighted by duration and extent prior to determining a Wind Peril value. In some embodiments, the Wind Peril value is weighted based on average duration and/or extent of the measured and/or extrapolated wind values.

In some embodiments of the present invention, determination of the Intensity Metric for the Storm Surge Peril includes analyzing aspects of the Storm Surge Peril. In some such embodiments, the analyzed aspects of the Storm Surge Peril include modeled surge height and inland penetration. In some such embodiments, modeled storm surge values associated with multiple modeled locations are used to extrapolate Storm Surge information for the HTI Location. In some embodiments, each modeled storm surge value is assessed in relation to coastal topography and relevant elevations. In some embodiments, each storm surge value is weighted based on relative topography and elevation of the relevant locations. In some embodiments, the Storm Surge Peril value is weighted based on the topography and elevation of the HTI Location.

In some embodiments of the present invention, determination of the Intensity Metric for the Rainfall Peril includes analyzing aspects of the Rainfall Peril. In some embodiments, the analyzed aspects of the Rainfall Peril include total accumulated rainfall and predicted urban and river flooding potential, especially in vulnerable watersheds. In some such embodiments, measured rainfall values and/or predicted flood values associated with multiple measuring locations and/or prediction locations, respectively, are used to extrapolate Rainfall Peril information for the HTI Location. In some embodiments, each rainfall value and/or flooding value is weighted based on relevant ground conditions and/or drainage patterns. In some embodiments, the Rainfall Peril value is weighted based on ground conditions and/or drainage patterns associated with the HTI Location.

In some embodiments of the present invention, determination of the Intensity Metric for the Tornado Peril includes analyzing aspects of the Tornado Peril. In some embodiments, the analyzed aspects of the Tornado Peril include quantity, size, and/or rating of tornadoes. In some such embodiments, Tornado Peril information for several locations is used to extrapolate Tornado Peril information for the HTI Location. In some embodiments, analyzed aspects of the Tornado Peril for each tornado is weighted based on the anticipated path of the tornado. In some embodiments, the Tornado Peril value is weighted based on the anticipated path of each tornado relative to the HTI Location.

In some embodiments, each Peril is scored individually using meteorological data and risk evaluation based on population and historical economic impact, producing a peril-specific intensity score. The threat index is then obtained from the weighted sum of peril-specific severity components, each multiplied by exposure factors. In some such embodiments, the HTI Score is calculated using the following equation (the “HTI Equation”):

$$HTI = {\sum }_{i = 1}^{4} {W}_{i} \times {H}_{i} \times {E}_{i}$$

In the HTI Equation, i corresponds to the peril type (i.e. Wind Peril, Rainfall Peril, Storm Surge Peril, and Tornado Peril) while wᵢ, Hᵢ, and Eᵢ represent a weighting factor, an Intensity Metric, and an Exposure Factor for the respective peril. In some embodiments, the values of the HTI Equation are based on a physical forecast data, such as rainfall, integrated wind energy, storm surge, and tornado probability.

In some embodiments, the Exposure Factor is calculated using the following equation (the “Exposure Equation”):

$${E}_{i} = \frac{{V}_{i}}{{A}_{i}}$$

In the Exposure Equation, Vᵢ represents the total value of at-risk assets (“HTI Value”) associated with the HTI Location, and Aᵢ represents the size of the HTI Location (the “HTI Size”). In some embodiments, the boundaries of the HTI Location, and therefore the HTI Size, are determined, at least in part, based on the anticipated area exposed to a relevant peril and/or to a relevant anticipated or measured level of such relevant peril. In some embodiments, the boundaries of a first HTI Location associated with a first peril are distinguishable from the boundaries of a second HTI Location for a second peril. In some embodiments, the HTI Value represents an asset-density-based exposure metric ($/km²), which facilitates scaling the HTI Score for the HTI Storm by how valuable the impacted area is. In some embodiments, the HTI Value is determined, at least in part, based on property value concentrations (residential, commercial, and industrial) and strategic values, such as the strategic value of critical infrastructure and transportation hubs. In some embodiments, asset value information is obtained from one or more public source, such as Eberenz or the like.

In some embodiments, the Exposure Factor is influenced, at least in part, by population density and anticipated issues attributable to the population density and/or the relevant peril type. In some such embodiments, population density information is obtained, at least in part, using publicly available information, such as the Gridded Population of the World collection available from NASA (available at https://www.earthdata.nasa.gov/data/projects/gpw), the entire disclosure of which is incorporated herein by reference. In some embodiments, exposure data is overlaid geographically with hurricane footprints to assess the number of people and/or the value of assets at risk for each peril.

The HTI Score is an aggregated and weighted composite value that is calculated based on relevant Intensity Metrics and Exposure Factors, thereby providing a threat index representing hurricane severity (“Hazard Intensity”), people and assets in harm's way (“Hazard Exposure”), and expected disruptions, damage, and loss (“Hazard Impact”). In some embodiments, the HTI Score can be scaled regionally or nationally and used to guide decision-making by emergency managers, insurers, utility providers, and businesses in real-time and post-event analysis.

In some embodiments, Hazard Intensity is represented in the HTI Equation, at least in part, by the intensity metric (Hᵢ). In some embodiments, Hazard Exposure is represented in the HTI Equation, at least in part, by the Exposure Factor (Eᵢ) and/or the weighting factor (wᵢ). In some embodiments, Hazard Impact is represented in the HTI Equation, at least in part, by the weighting factor (wᵢ).

In some embodiments, the HTI Score provides unique utility for users by transforming meteorological hazard data into actionable, asset-aware threat intelligence that directly supports operational, financial, and risk-based decision-making across weather-sensitive industries. In some embodiments, users include energy providers, agricultural operators, commodity traders, transportation networks, and insurance and risk management entities. In some such embodiments, users require forecasts that extend beyond physical storm characterization and instead quantify a business-relevant threat. The HTI Score uniquely fulfills this requirement by integrating multi-peril hurricane hazards with economic asset exposure data at spatial and temporal resolutions. In some such embodiments, the integration is aligned with operational forecast products.

In some embodiments, the present invention includes a method of utilizing a system of the present invention to assess an anticipated threat to a distributed portfolio of energy infrastructure assets, including power generation facilities, substations, transmission lines, offshore platforms, and fuel terminals. In some such embodiments, meteorological forecast data is ingested from numerical weather prediction models and ensemble guidance to generate peril-specific hazard fields for wind speed and duration, rainfall accumulation, storm surge height, and tornado occurrence probability. These hazard fields are spatially overlaid with asset location and replacement value data. An HTI Score is calculated for each asset and aggregated across the portfolio to identify facilities with the highest expected operational disruption. The resulting threat scores are then used to inform decisions regarding preemptive shutdowns, crew staging, fuel inventory repositioning, and post-storm restoration prioritization. In some such embodiments, the present invention enables energy providers to move beyond wind-based hurricane categories and instead optimize operational decisions based on the dominant peril threatening each asset.

In some embodiments, the present invention is implemented as a portfolio-level risk assessment tool for insurance and reinsurance. For a HTI Storm, peril-specific hazard intensities are computed across the projected storm footprint while economic exposure data, including insured property values and policy concentrations, are mapped to the affected regions. The inputs are integrated to generate a normalized threat score for each peril and a composite threat index (HTI Score) for the event. In some such embodiments, the present invention is used to estimate relative loss potential across regions

In some embodiments, the present invention includes deriving an HTI Score for a current storm and one or more historical storms (each an HTI Storm) for the purpose of comparing the same. In some such embodiments, known economic information associated with the historical HTI Storms is used to extrapolate anticipated economic information associated with the current HTI Storm.

In some embodiments, the present invention includes deriving an HTI Score for one or more projected or hypothetical storms (each an HTI Storm). In some such embodiments, HTI Scores from projected or hypothetical HTI Storms are used to support or determine strategies for capital allocation, reinsurance purchasing, and/or event responses.

In some embodiments, the present invention is used to assess hurricane threat to transportation and logistics networks, including ports, rail corridors, highways, and distribution centers. In some embodiments, forecast hazard data is combined with infrastructure capacity, throughput value, and geographic dependency data to calculate HTI Scores for HTI Locations along critical transportation corridors. In some embodiments, rainfall and storm surge components are weighted more heavily for low-lying ports and intermodal hubs, while wind and tornado components are emphasized for inland distribution centers. In some such embodiments, the present invention facilitates and/or includes rerouting shipments, pre-positioning inventory, and/or adjusting delivery schedules based on forecasted disruption risk rather than generalized storm advisories.

Various embodiments of the present invention utilize, encompass, or are facilitated by computer programs, devices, systems, methods, and the like. Various embodiments of computer programs, devices, systems, and methods are implemented in hardware, software, firmware, or combinations thereof, such as by using a central management system (e.g. TCS or other central computer control system), which broadly comprises server devices, computing devices, a communications network, and the like. Various embodiments of the server devices include computing devices that provide access to one or more general computing resources, such as Internet services, electronic mail services, data transfer services, and the like. In some embodiments the server devices also provide access to a database that stores information and data, with such information and data including, without limitation, system user information (e.g. project ID, account number, etc.), or the like, or other information and data necessary and/or desirable for the implementation of the computer program, devices, systems, and methods of the present invention.

Various embodiments of server devices and computing devices include any device, component, or equipment with a processing element and associated memory elements. In some embodiments the processing element implements operating systems, and in some such embodiments is capable of executing a computer program, which is also generally known as instructions, commands, software code, executables, applications (apps), and the like. In some embodiments the processing element includes processors, microprocessors, microcontrollers, field programmable gate arrays, and the like, or combinations thereof. In some embodiments the memory elements are capable of storing or retaining the computer program and in some such embodiments also store data, typically binary data, including text, databases, graphics, audio, video, combinations thereof, and the like. In some embodiments the memory elements also are known as a “computer-readable storage medium” and in some such embodiments include random access memory (RAM), read only memory (ROM), flash drive memory, floppy disks, hard disk drives, optical storage media such as compact discs (CDs or CDROMs), digital video disc (DVD), Blu-Ray™, and the like, or combinations thereof. In addition to these memory elements, in some embodiments the server devices further include file stores comprising a plurality of hard drives, network attached storage, or a separate storage network.

Various embodiments of the computing devices specifically include mobile communication devices (including wireless devices), work stations, desktop computers, laptop computers, palmtop computers, tablet computers, portable digital assistants (PDA), smart phones, wearable devices and the like, or combinations thereof. Various embodiments of the computing devices also include voice communication devices, such as cell phones or landline phones. In some preferred embodiments, the computing device has an electronic display that is operable to display visual graphics, images, text, etc. In certain embodiments, the computer program of the present invention facilitates interaction and communication through a graphical user interface (GUI) that is displayed via the electronic display. The GUI enables the user to interact with the electronic display by touching or pointing at display areas to provide information to the user control interface, which is discussed in more detail below. In additional preferred embodiments, the computing device includes an optical device such as a digital camera, video camera, optical scanner, or the like, such that the computing device can capture, store, and transmit digital images and/or videos, bar codes or other identification information.

In some embodiments a computing device includes a user control interface that enables one or more users to share information and commands with the computing devices or server devices. In some embodiments, the user interface facilitates interaction through the GUI described above or, in other embodiments comprises one or more functionable inputs such as buttons, keyboard, switches, scrolls wheels, voice recognition elements such as a microphone, pointing devices such as mice, touchpads, tracking balls, styluses, or the like. Embodiments of the user control interface also include a speaker for providing audible instructions and feedback. Further, embodiments of the user control interface comprise wired or wireless data transfer elements, such as a communication component, removable memory, data transceivers, and/or transmitters, to enable the user and/or other computing devices to remotely interface with the computing device.

In various embodiments the communications network will be wired, wireless, and/or a combination thereof, and in various embodiments will include servers, routers, switches, wireless receivers and transmitters, and the like, as well as electrically conductive cables or optical cables. In various embodiments the communications network will also include local, metro, or wide area networks, as well as the Internet, or other cloud networks. Furthermore, some embodiments of the communications network include cellular or mobile phone networks, as well as landline phone networks, public switched telephone networks, fiber optic networks, or the like.

Various embodiments of both the server devices and the computing devices are connected to the communications network. In some embodiments server devices communicate with other server devices or computing devices through the communications network. Likewise, in some embodiments, the computing devices communicate with other computing devices or server devices through the communications network. In various embodiments, the connection to the communications network will be wired, wireless, and/or a combination thereof. Thus, the server devices and the computing devices will include the appropriate components to establish a wired or a wireless connection.

Various embodiments of computer programs associated with present invention run on computing devices. In other embodiments an associated computer program runs on one or more server devices. Additionally, in some embodiments a first portion of the program, code, or instructions execute on a first server device or a first computing device, while a second portion of the program, code, or instructions execute on a second server device or a second computing device. In some embodiments, other portions of the program, code, or instructions execute on other server devices as well. For example, in some embodiments information is stored on a memory element associated with the server device, such that the information is remotely accessible to users of the computer program via one or more computing devices. Alternatively, in other embodiments the information is directly stored on a memory element associated with the one or more computing devices of the user. In additional embodiments of the present invention, a portion of the information is stored on the server device, while another portion is stored on the one or more computing devices. It will be appreciated that in some embodiments the various actions and calculations described herein as being performed by or using a computer program will actually be performed by one or more computers, processors, or other computational devices, such as the computing devices and/or server devices, independently or cooperatively executing portions of the computer program.

Various embodiments of the present invention are accessible via an electronic resource, such as an application, a mobile “app,” or a website. In certain embodiments, portions of a computer program are embodied in a stand-alone program downloadable to a user's computing device or in a web-accessible program that is accessible by the user's computing device via the network. For some embodiments of the stand-alone program, a downloadable version of the computer program is stored, at least in part, on the server device. A user downloads at least a portion of the computer program onto the computing device via the network. After the computer program has been downloaded, the program is installed on the computing device in an executable format. For some embodiments of the web-accessible computer program, the user will simply access the computer program via the network (e.g., the Internet) with the computing device.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, various embodiments of the present technology include a variety of combinations and/or integrations of the embodiments described herein.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall within the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. A method of determining an HTI Score for an HTI Location associated with an HTI Storm, the method comprising:
determining a weighting factor, an Intensity Metric, and an Exposure Factor for each of a plurality of Perils;
determining a plurality of product values, each product value of the plurality of product values being the product of the weighting factor, the Intensity Metric, and the Exposure Factor for a respective Peril of the plurality of Perils; and
determining the summation of the plurality of product values, the summation being equal to the HTI Score.

2. The method of claim 1, wherein the HTI Score represents a Hazard Intensity and a Hazard Exposure, the Hazard Intensity being associated with the severity of the HTI Storm and the Hazard Exposure being associated with people and assets at the HTI Location.

3. The method of claim 2, wherein the HTI Score also represents a Hazard Impact, the Hazard Impact being associated with expected disruptions, damage, and loss caused by the HTI Storm at the HTI Location.

4. The method of claim 3, wherein the plurality of Perils includes a Wind Peril, a Storm Surge Peril, a Rainfall Peril, and a Tornado Peril.

5. The method of claim 4, wherein determining the Intensity Metric for each Peril comprises analyzing aspects associated with each Peril, wherein the analyzed aspects for each Peril comprises:
maximum sustained wind speeds and maximum measured wind gusts for the Wind Peril;
surge height and inland penetration for the Storm Surge Peril;
total accumulated rainfall and predicted urban and river flooding potential for the Rainfall Peril; and
quantity and rating for the Tornado Peril.

6. The method of claim 5, wherein at least some values used for each of the analyzed aspects are extrapolated values.

7. The method of claim 5, wherein determining the analyzed aspects of each Peril is weighted by:
duration and extent for the Wind Peril;
relative topography and elevation for the Storm Surge Peril;
relevant ground conditions and drainage patterns for the Rainfall Peril; and
proximity of an anticipated path for the Tornado Peril.

8. The method of claim 7, wherein the HTI Score is a comprehensive metric designed for anticipating, preparing for, assessing, and responding to the HTI Storm.

9. The method of claim 8, wherein the Exposure Factor for each Peril is determined by dividing an associated HTI Value by an associated HTI Size.

10. The method of claim 8, wherein the Exposure Factor is influenced by an associated population density.

11. A method of optimizing preparations for and responses to a selected Hurricane, the method comprising:
determining a first location anticipated to be impacted by the selected Hurricane;
assessing socioeconomic exposure associated with the first location and assigning impact component values for each of a plurality of hazard types; and
assessing the total destructive potential of the selected Hurricane and assigning intensity component values for each of the plurality of hazard types.

12. The method of claim 11, wherein assigning intensity component values comprises analyzing aspects of each hazard type of the plurality of hazard types, the plurality of hazard types comprising wind, storm surge, rainfall, and tornadoes.

13. The method of claim 12, further comprising determining a weight value for each of the hazard types.

14. The method of claim 13, further comprising determining a severity component for each hazard type by multiplying the respective impact component by the respective intensity component.

15. The method of claim 14, further comprising determining a first threat index score for the first location, the first threat index score being a weighted sum of the severity components for the first location.

16. The method of claim 15, further comprising determining a second threat index score associated with a second location and determining resource allocation for the first and second locations based on respective first and second threat index scores.

17. The method of claim 16, further comprising rerouting shipments, pre-positioning inventory, and adjusting delivery schedules based on the respective first and second threat index scores.

18. The method of claim 15, further comprising determining a second threat index score for a previous Hurricane and determining resource allocation for the selected Hurricane based on the first and second threat index scores and resource requirements associated with the previous Hurricane.

19. The method of claim 15, further comprising mapping insurance policy concentrations associated with the first location.

20. The method of claim 15, further comprising providing an evacuation warning for the first location upon the first threat index score reaching an evacuation threshold value.
